(19) United States
(12) Patent Application Publication
(10) Pub. No.: US 2026/0128945 A1
(43) Pub. Date: May 7, 2026

(54) METHOD FOR OPERATING A SERVICE PROVISION NETWORK, CONTROL DEVICE FOR CARRYING OUT SUCH A METHOD AND SERVICE PROVISION NETWORK HAVING SUCH A CONTROL DEVICE

(71) Applicant: Rolls-Royce Solutions GmbH, Friedrichshafen (DE)

(72) Inventors: Carsten Schäfer, Ravensburg (DE); Alexander Bernhard, Meckenbeuren (DE); Dennis Beermann, Konstanz (DE)

(73) Assignee: Rolls-Royce Solutions GmbH, Friedrichshafen (DE)

(21) Appl. No.: 19/032,260

(22) Filed: Jan. 20, 2025

Related U.S. Application Data
(63) Continuation of application No. PCT/EP2023/069830, filed on Jul. 17, 2023.

(30) Foreign Application Priority Data
Jul. 20, 2022 (DE) 10 2022 118 176.6
Jul. 17, 2023 (WO) PCT/EP2023069830

(51) Int. Cl. H04L 41/0806; H04L 41/147

(52) U.S. Cl. CPC H04L 41/0806; H04L 41/147

(57) ABSTRACT

A method for operating a service provision network includes: providing the service provision network includes a first service provision device with a predeterminable performance and a second service provision device with a non-predeterminable performance; determining an operating plan for operating the network via a prediction horizon, depending on a load prediction of a load demand to the network and a performance prediction for the second service provision device for the prediction horizon, which is a respectively same predetermined prediction horizon; determining the operating plan depending on a load confidence interval of the load prediction and on a performance confidence interval of the performance prediction, such that, at any point in time within the prediction horizon, a current performance prediction for the network is at least as great as a current upper limit of the load confidence interval; and operating then the service provision network according to the operating plan.

### CROSS REFERENCE TO RELATED APPLICATIONS

This is a continuation of PCT application no. PCT/EP2023/069830, entitled “METHOD FOR OPERATING A SERVICE PROVISION NETWORK, CONTROL DEVICE FOR CARRYING OUT SUCH A METHOD AND SERVICE PROVISION NETWORK HAVING SUCH A CONTROL DEVICE”, filed Jul. 17, 2023, which is incorporated herein by reference. PCT application no. PCT/EP2023/069830 claims priority to German patent application no. 10 2022 118 176.6, filed Jul. 20, 2022, which is incorporated herein by reference.

### BACKGROUND OF THE INVENTION

### 1. Field of the Invention

The present invention relates to service provision networks.

### 2. Description of the Related Art

Generally, service provision devices physically track the load demands placed on them.

An operating plan for a service provision network can be developed for a prediction horizon depending on a load prediction for the service provision network. However, the probability of the load prediction actually occurring accurately is generally very low. Thus, there is also a very high probability of unwanted system behavior occurring in the prediction horizon due to a non-occurrence of a load prediction, especially in the worst case scenario of insufficient performance being available in the service provision network.

Moreover, a performance prediction for the prediction horizon can be created for the operation of a service provision device with non-predeterminable performance, in particular a photovoltaic system, in order to develop the operating plan for the service provision network including the service provision device with non-predeterminable performance. Regarding the performance prediction, the probability that the performance prediction will actually occur exactly is very low. Thus, there is a very high probability that undesirable system behavior will occur in the prediction horizon due to a performance prediction not occurring, in particular in the worst case scenario of insufficient performance being available in the service provision network.

A disadvantage of such methods for determining the operating plan for the service provision network is that the uncertainties of the load prediction and/or performance prediction are not considered.

What is needed in the art is a method for operating a service provision network, a control device for carrying out such a method, and a service provision network including such a control device, wherein the aforementioned disadvantages are rectified, at least partially, and are optionally avoided.

### SUMMARY OF THE INVENTION

The present invention relates to a method for operating a service provision network, a control device for carrying out such a method, and a service provision network having such a control device.

The present invention provides a method for operating a service provision network having at least one first service provision device with predeterminable performance and at least one second service provision device with non-predeterminable performance. Depending on a load prediction of a load demand to the service provision network, and a performance prediction for the at least one second service provision device for the respectively same predetermined prediction horizon, an operating plan for operating the service provision network is determined at least via the prediction horizon. The operating plan is additionally determined depending on a load-confidence interval of the load prediction and a performance-confidence interval of the performance prediction in such a way that, at any point in time within the prediction horizon, a current performance prediction for the service provision network—in particular taking into account the performance confidence interval—is at least as great as a current upper limit of the load confidence interval. The service provision network is subsequently operated according to the operating plan.

By considering the confidence intervals it is advantageously possible to include the uncertainties of the load prediction and the performance prediction in the determination of the operating plan, thereby reducing and/or avoiding the probability of undesirable system behavior.

A first performance of the at least one first service provision device with a predeterminable performance is designated P₁. First performance P/is specified in particular by the operating plan; in particular, the operating plan serves to determine first performance P₁ for the prediction horizon. In addition, a second performance of the at least one second service provision device with non-predeterminable performance is designated P₂, whereby within the prediction horizon second performance P₂ is determined based on the performance prediction. In addition, the load demand for the service provision network is designated P_{load}. In addition, the current upper limit of the load confidence interval is designated P_{load,max}. In addition, the current lower limit of the load confidence interval is designated P_{load,min}. In addition, the current upper limit of the performance confidence interval is designated P_{2,max}. In addition, a current lower limit of the performance confidence interval is designated P_{2,min}.

A current performance is understood to be in particular a performance which existed at a certain point in time in the past, which is current now, or will exist at a certain point in time within the prediction horizon. Correspondingly, a current load demand is understood to be in particular a load demand that existed at a certain point in time in the past, which is current now, or will exist at a certain point in time within the prediction horizon. Moreover, a current upper limit and a current lower limit are understood to be in particular a value that was selected at a certain point in time in the past, is currently selected, or is selected for a certain point in time within the prediction horizon.

A predicted performance is understood to mean, in particular, a performance within the prediction horizon, which is established from first performance P₁ within the prediction horizon, second performance P₂ within the prediction horizon, which is known from the performance prediction, and from the performance confidence interval within the prediction horizon. Thus, the uncertainties of the performance prediction and/or the uncertainties of the performance confidence interval are included in the predicted performance.

Taking into account the definitions of current performance and predicted performance, a predicted current performance is understood to be, in particular, a performance predicted for a specific point in time within the prediction horizon, The predicted current performance then results in particular as the sum of first performance P₁ and a value predicted for second performance P₂, whereby the value predicted for the second performance can be selected differently within the performance confidence interval, in particular depending on a need for reliability or another option.

In particular, at any time, the current upper limit of load confidence interval P_{load,max} is at least as great as load demand P_{load}. In addition, at any time, the current lower limit of load confidence interval P_{load,min} is at most as great as load demand P_{load}.

In particular, at any time, the current upper limit of the performance confidence interval P_{2,max} is at least as large as the predicted or forecast second performance P₂. In addition, at any time, the instantaneous lower limit of the performance confidence interval P_{2,min} is at most as large as the predicted or forecast second performance P₂.

In one embodiment, a device selected from a group consisting of a generator that is operatively connected to a controllable drive machine, an internal combustion engine, an electrical machine that is operatively connected to an internal combustion engine, in particular a genset, and an energy storage device is used as the at least one first service provision device with predeterminable performance.

In one embodiment, a heat storage device is used as the energy storage device.

Alternatively, or in addition, a mechanical storage device selected from a group consisting of a flywheel accumulator, a spring device, a pumped storage device, a compressed air storage device, and a lifting storage device is used as the energy storage device.

Alternatively, or in addition, an electrical storage device selected from a group consisting of a battery, in particular an accumulator, and a capacitor is used as the energy storage device.

In one embodiment, a photovoltaic system is used as the at least one second service provision device with non-predeterminable performance. Alternatively, or in addition, a wind turbine is used as the at least one second service provision device with non-determinable performance. Alternatively or in addition, a hydroelectric power plant is used as the at least one second service provision device with non-determinable performance.

In the context of the present technical teaching, a prediction horizon is understood in particular to be a predetermined time period T originating from a current point in time t₀ to a future point in time t₁=t₀ +T.

In the context of the present technical teaching, a load confidence interval is understood in particular to be a range of values which will contain an actual occurring load demand on the service provision network with a certain, in particular predeterminable, probability. In particular, the load confidence interval is determined based on the load prediction and a positive and/or negative load difference from the load prediction. In particular, the positive and/or negative load difference—which is in particular predefined and/or determined from at least one histogram—is added to the load prediction in order to determine the load confidence interval. Thus, the equations below apply in particular to the upper limit and the lower limit of the load confidence interval

$$\begin{matrix}{P}_{Load , max} ( t ) = {P}_{Load} ( t ) + {P}_{Load , Diff +} ( t ) \\ {P}_{Load , min} ( t ) = {P}_{Load} ( t ) + {P}_{Load , Diff -} ( t ) ,\end{matrix}$$

wherein P_{Load,Diff+} denotes the positive load difference and P_{Load,Diff-} denotes the negative load difference.

In the context of the present technical teaching, a performance confidence interval is understood in particular to be a range of values which will contain an actual provided performance of the service provision network with a certain, in particular predeterminable, probability. In particular, the performance confidence interval is determined based on the performance prediction and a positive and/or negative performance difference from the performance prediction. In particular, the positive and/or negative performance difference—which is in particular predefined and/or determined from at least one histogram—is added to the performance prediction in order to determine the performance confidence interval. Thus, the following equations apply in particular to the upper and lower limit of the performance confidence interval:

$$\begin{matrix}{P}_{2 , max} ( t ) = {P}_{2} ( t ) + {P}_{2 , Diff +} ( t ) \\ {P}_{2 , min} ( t ) = {P}_{2} ( t ) + {P}_{2 , Diff -} ( t ) ,\end{matrix}$$

wherein P_{2,Diff+} denotes the positive performance difference and P_{2,Diff-} denotes the negative performance difference.

In one arrangement, at least one point in time, optionally a plurality of points in time, will be assigned a positive load difference to determine the load confidence interval within the prediction horizon. Alternatively, or in addition, at least one point in time, optionally a plurality of points in time, will be assigned a negative load difference to determine the load confidence interval. In addition, at least one point in time, optionally a plurality of points in time, will be assigned a positive performance difference to determine the performance confidence interval. Alternatively, or in addition, at least one point in time, optionally a plurality of points in time, will be assigned a negative performance difference to determine the performance confidence interval. Optionally, the positive and/or negative differences associated with a first point in time and a second point in time are identical if the first point in time and the second point in time are at a temporal distance of 168 hours—in particular 7 days—in particular 24 hours, and/or a multiple of 168 hours—in particular 7 days—in particular 24 hours.

The method can be implemented continuously or temporally timed, in particular with a predetermined cycle time. If the method is temporally timed, separate values for the current load demand, the current performance and/or the confidence intervals can be assigned to each cycle within the prediction horizon. However, it is also possible to set these values only for greater time intervals, each of which includes a plurality of cycles. The corresponding values can then be kept constant within the greater time intervals, or they can be interpolated for individual cycles within the greater time intervals.

In particular, load prediction P_{load}(t) is provided to the service provision network by a consumer, an operator of the service provision network or an operator of a higher level provision network, at least for the prediction horizon. Alternatively, load prediction P_{load}(t) is determined based on a historical load profile.

In particular, performance prediction P₂(t) is provided to the service provision network at least for the prediction horizon. In particular, the performance prediction P₂(t) is determined based on a historical performance curve and/or on a weather forecast, in particular on the basis of forecast wind or sunshine hours.

In one embodiment, the operating plan is determined in such a way that the sum of first performance P; and the current upper limit of performance confidence interval P_{2,max} at any time within the prediction horizon is at least as great as the current upper limit of the load confidence interval P_{load,max}, and thus in particular the equation

$${P}_{1} ( t ) + {P}_{2 , max} ( t ) \geq {P}_{Load , max} ( t )$$

for all times t in the interval [t₀; t₁] is satisfied. This allows in particular a cost-effective operation of the service provision network while accepting a certain residual risk of not being able to meet the load demand, at least for a short time. The predicted current performance Pₚ(t) is provided in this case by

$${P}_{p} ( t ) = {P}_{1} ( t ) + {P}_{2 , max} ( t ) .$$

In a further arrangement the operating plan is determined in such a way that the sum of first performance P₁ and second performance P₂ at any time within the prediction horizon is at least as great as the current upper limit of the load confidence interval P_{Load,max}, and thus the equation

$${P}_{1} ( t ) + {P}_{2} ( t ) \geq {P}_{Load , max} ( t )$$

for all times t in interval [t₀; t₁] is satisfied. This arrangement, in particular, represents a compromise between cost-effective operation of the service provision network and a risk minimization with regard to the fulfillment of the requested load. The predicted current performance Pₚ(t) is provided in this case by

$${P}_{p} ( t ) = {P}_{1} ( t ) + {P}_{2} ( t ) .$$

A further development of the invention provides that the current performance predicted for the service provision network is calculated as the sum of the current lower limit of the performance confidence interval and the current performance of the at least one first service provision device. This facilitates particularly reliable fulfillment of the load demand at any time within the prediction horizon.

The operating plan is determined in particular so that the sum of first performance P₁ and the current lower limit of performance confidence interval P_{2,min} at any point in time within the prediction horizon is at least as great as the current upper limit of the load confidence interval P_{load, max}, and thus the equation

$${P}_{1} ( t ) + {P}_{2 , min} ( t ) \geq {P}_{load , max} ( t )$$

is fulfilled for all points in time t in interval [t₀; t₁]. The predicted current performance Pₚ(t) is provided in this case by

$${P}_{p} ( t ) = {P}_{1} ( t ) + {P}_{2 , min} ( t ) .$$

A further development of the invention provides that the operating plan is moreover determined depending upon at least one secondary condition.

In particular, it is possible by way of the at least one secondary condition to suitably provide the current performance of the service provision network by way of the first performance of the at least one first service provision device and the second performance of the at least one second service provision device.

In one embodiment, the at least one secondary condition is considered to be a secondary condition selected from a group consisting in particular of a minimum temporally variable first performance P_{1,min} (t), in particular a temporally variable maximum first performance P_{1,max} (t), a minimum temporal change of first performance \dot{P}_{1,min}, and a maximum temporal change of the first performance \dot{P}_{1,max}.

According to a further development of the invention, it is provided that the costs of the service provision network are minimized as the at least one secondary condition. This makes it advantageously possible to operate the service provision network as efficiently and/or economically as possible.

In particular, a cost function is minimized, wherein the cost function is identified with K.

In one embodiment, the operating costs of the service provision network are determined as the costs of the service provision network. Cost function K is thus determined based on operating costs k_{b,1} of the at least one first service provision device and on the operating costs k_{b,2} of the at least one second service provision device, wherein the operating costs in particular also include maintenance costs of the service provision network. The following therefore applies to the cost function:

$$K = {k}_{b , 1} {P}_{1} + {k}_{b , 2} {P}_{2}$$

In another arrangement, the energy costs of the service provision network are determined as the costs of the service provision network. Thus, cost function K is determined based on energy costs k_{e,1} of the at least one first service provision device, the energy costs k_{e,2} of the at least one second service provision device and an additional designation Z, wherein additional designation Z contains in particular maintenance costs of the energy provision network. The following therefore applies to the cost function:

$$K = {k}_{3 , 1} {P}_{1} + {k}_{3 , 2} {P}_{2} + Z ( {P}_{1} , {P}_{2} )$$

According to a further development of the invention, it is provided that the operating plan is determined by way of robust optimization. Advantageously, robust optimization methods are particularly suitable for determining the operating plan subject to uncertainties in the form of the load confidence interval and/or the performance confidence interval.

A further development of the invention provides that at least one confidence interval, selected from the load confidence interval and the performance confidence interval, is determined from historical values for load or performance.

A further development of the invention provides that deviations of the historical values from historical value predictions assigned to the historical values are determined, wherein the lower limit and the upper limit of the at least one confidence interval are determined on the basis of the defined deviations in such a way that, for a predetermined proportion of the deviations, a sum of the respective deviation and the load prediction and/or the performance prediction is within the respective confidence interval.

In particular, historical values of a specific parameter, in particular of the load demand and/or the second performance, have a determination point in time, a predicted value of the parameter and an actual value of the parameter. In particular, the positive and/or negative differences—in particular, the load differences and/or the performance differences—are determined using at least one histogram, optionally a plurality of histograms, of the historical values.

In one arrangement, a plurality of historical values of the load demand, in particular a plurality of specific deviations of the load demand, are entered into precisely one load demand histogram, wherein the precisely one load demand histogram is used to determine the load confidence interval within the prediction horizon. Alternatively, or in addition, a plurality of historical values of the second performance, in particular a plurality of specific deviations of the second performance, are entered into exactly one performance histogram, wherein the precisely one performance histogram is used to determine the performance confidence interval within the prediction horizon. In particular, a histogram of deviations from the prediction value randomly set to zero is created for at least one histogram time point at the determination time point identical to the respective histogram time point. For example, 12:00 noon can be selected as the histogram time point, in particular 12:00 noon on a predetermined weekday, wherein the histogram includes deviation values for a plurality of days. The histogram then contains information, in particular of the frequency of certain deviations from the predicted value at the histogram time.

In another arrangement, a histogram is created respectively for a plurality of histogram time points. In particular, a historical value is entered into exactly one histogram. Optionally a historical value is entered into the histogram of which the associated histogram time point is identical to the determination point in time of the historical value. In particular, the histogram time point is a specific time of day and/or a day of the week. Alternatively, or in addition, the histogram time point is assigned to a season—in particular winter, spring, summer and autumn. Alternatively, or in addition, the specific histogram time point is assigned in particular to an event—in particular, holidays, in particular Christmas, Easter, Pentecost, and non-holidays or vacation time and non-vacation time. If the histogram time point is not a specific time, but is assigned to a longer period of time, a suitable allocation, in particular averaging, of the predicted values that are present within the time period and of deviations, is carried out in order to determine the entries in the histogram. Alternatively, a reference point in time within the longer period is set as the histogram point in time.

In particular, two consecutive histogram time points are spaced at a temporal difference from one another by at least 5 minutes, especially at least 10 minutes, especially at least 15 minutes to a maximum of 12 hours, especially to a maximum of 5 hours, especially to a maximum of 2 hours, especially to a maximum of one hour, in particular to a maximum of 30 minutes. This advantageously makes it possible to create a histogram for a plurality of histogram time points, especially for one day, thereby determining confidence intervals associated with the histogram time points. If a time point in the interval [t₀; t₁] corresponds to one of the histogram time points, the histogram of the respective histogram time point is used for the time point. If a time point in the interval [t₀; t₁] does not correspond to one of the histogram time points, the histogram of the immediately preceding histogram time point or an interpolation between the histogram of the immediately preceding histogram time point and the histogram of an immediately subsequent histogram time point is used for the time point.

In particular, for each parameter, that is for the load demand on the one hand and for the second performance on the other hand, a corresponding histogram is carried out—as described above and below—from which the associated confidence intervals are determined.

In particular, a first deviation, in particular a positive value, and a second deviation, in particular a negative value, are selected in the respective histogram in such a way that a predetermined proportion of the determined deviations, which corresponds to the predetermined probability, is between the first deviation and the second deviation. The first deviation is then used in particular as the positive load difference or the positive performance difference. The second deviation is used accordingly as the negative load difference or the negative performance difference.

In particular, at least 50% to at most 100%, optionally 60%, optionally 70%, optionally 75%, optionally 80%, optionally 90%, optionally 92%, optionally 94%, optionally 95%, optionally 96%, optionally 98%, optionally 99%, is considered as a predetermined proportion.

In particular, the first deviation and the second deviation are determined by calculating percentiles of deviations. In particular, the second deviation is considered to be a deviation value assigned to u percentile, wherein parameter u is considered to be a value of at least 0.01 to a maximum of 0.49, optionally 0.05, optionally 0.1, optionally 0.15, optionally 0.2, optionally 0.25, optionally 0.3, optionally 0.35, optionally 0.4, optionally 0.45. Alternatively, or in addition, the first deviation is considered in particular to be a deviation value assigned to a o percentile, wherein parameter o is considered to be a value of at least 0.51 to at most 0.99, optionally 0.55, optionally 0.6, optionally 0.65, optionally 0.7, optionally 0.75, optionally 0.8, optionally 0.85, optionally 0.9, optionally 0.95. In particular, parameters u and o are selected so that the predetermined proportion is obtained. Parameter u and parameter o are particularly optionally selected symmetrically to value 0.5, so that the formula

$$\vert u - 0 , 5 \vert = \vert o - 0 , 5 \vert$$

applies. In particular, the median is referred to as the 0.5 percentile.

A further development of the invention provides that the predetermined proportion is selected depending on a demand parameter, in particular selected from a customer request, a relevance of a facility to be supplied with service, or an application, and a system relevance value.

In one embodiment, the predetermined proportion is selected depending on the system relevance value in accordance with how system-relevant the facility to be supplied with services is. In particular, the predetermined proportion is selected to be greater the more system-relevant a continuous provision of services is for the facility to be supplied with service. In particular, the predetermined proportion is chosen to be greater for a hospital to be supplied with services than for a residential building to be supplied with services.

The present invention also provides a control device of a service provision network, wherein the control device is set up to carry out a method according to the invention or a method according to one or more of the previously described embodiments. The control device is optionally designed as a computing device, particularly optionally as a computer, or as a controller, in particular as a controller of a service provision network. In connection with the control device, advantages arise in particular, that have already been explained in connection with the method.

The control device is optionally designed to be operatively connected to the at least one first service provision device with predeterminable performance and the at least one second service provision device with non-predeterminable performance and designed to control them respectively.

The present invention also provides a service provision network with at least one first service provision device with a predeterminable performance, at least one second service provision device with a non-predeterminable performance and a control device according to the invention or a control device according to one or a number of the previously described embodiments. In connection with the service provision network, the advantages arise in particular, that have already been explained in connection with the method and the control device.

The control device is operatively connected to the at least one first service provision device with predeterminable performance and the at least one second service provision device with non-predeterminable performance and is arranged to control them respectively.

### BRIEF DESCRIPTION OF THE DRAWINGS

The invention is explained in further detail below with reference to the drawing. The following is shown: The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of one design example of a service provision network;

FIG. 2 is a flow chart of a design example of a method to operate the service provision network; and

FIG. 3 is a flow chart of a design example for determining a confidence interval from historical values.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

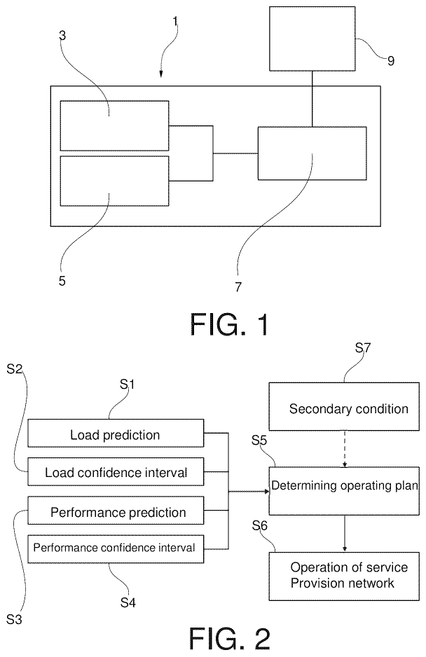

FIG. 1 shows a schematic illustration of a design example of a service provision network 1.

Service provision network 1 has at least one first service provision device 3 with a predeterminable performance and at least one second service provision device 5 with a non-predeterminable performance. Service provision network 1 also has a control device 7.

Control device 7 is operatively connected to the at least one first service provision device 3 with a predeterminable performance and the at least one second service provision device 5 with a non-predeterminable performance and is set up to control them respectively. Control device 7 is also set up to carry out a method for operating the service provision network 1 and to determine an operating plan for operating service provision network 1, wherein service provision network 1 optionally receives a load demand from a facility 9. The method is explained in more detail below with reference to FIG. 2.

FIG. 2 shows a flow chart of a design example of the method for operating service provision network 1.

In a first step S1, a load prediction of a load demand is specified for service provision network 1 for a predetermined prediction horizon.

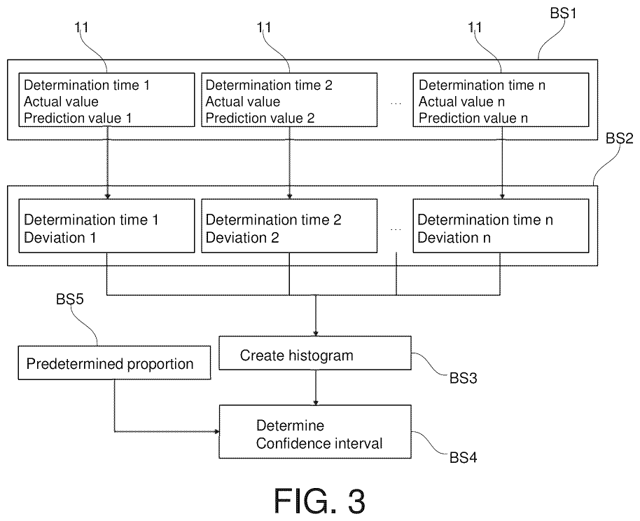

In a second step S2, a load confidence interval of the load prediction is specified and/or determined. In particular, a method for determining the load confidence interval is explained in more detail with reference to FIG. 3.

In a third step S3, a performance prediction for the at least one second service provision device 5 with non-determinable performance is specified for the predetermined prediction horizon.

In a fourth step S4, a performance confidence interval of the performance prediction is specified and/or determined. In particular, a method for determining the performance confidence interval is explained in more detail with reference to FIG. 3.

In particular first step S1 is carried out, temporally before third step S3. Alternatively, third step S3 is carried out temporally before first step S1. Alternatively, first step S1 and third step S3 are carried out simultaneously.

In particular, second step S2 is carried out after first step S1. Alternatively, first step S1 and second step S2 are carried out simultaneously.

In particular, fourth step S4 is carried out after third step S3. Alternatively, third step S3 and fourth step S4 are carried out simultaneously.

Optionally, the load confidence interval of the load prediction is determined in second step S2 from historical load demands. Deviations of the historical load demands from the load predictions assigned to the historical load demands are optionally determined, whereby a lower limit and an upper limit of the load confidence interval are determined on the basis of the determined deviations in such a way that a sum of the respective deviation and the load prediction and/or the performance prediction are within the respective confidence interval for a predetermined proportion of the deviations. In particular, the predetermined proportion is selected depending on a demand parameter. Optionally, the demand parameter is a customer request and/or a relevance of a facility or application to be supplied with service and/or a system relevance value.

Optionally, the performance confidence interval of the performance prediction is determined in the fourth step S4 from historical performances of the at least one second service provision device 5. Optionally, deviations of the historical performances from the performance predictions associated with the historical performances are determined, wherein a lower limit and an upper limit of the performance confidence interval are determined on the basis of the determined deviations so that for a predetermined proportion of the deviations a sum of the respective deviation and the load prediction and/or the performance prediction is within the respective confidence interval. In particular, the predetermined proportion is selected depending on a demand parameter. Optionally, the demand parameter is a customer request and/or a relevance of a facility or application to be supplied with services and/or a system relevance value.

In a fifth step S5, an operating plan is determined depending on the load prediction from first step S1, the load confidence interval from second step S2, the performance prediction from third step S3 and the performance confidence interval from fourth step S4 such that at any time within the prediction horizon a current performance prediction for service provision network 1 is at least as great as a current upper limit of the load confidence interval. In particular, the performance currently provided by service provision network 1 is calculated as the sum of a current lower limit of the performance confidence interval and a current performance of the at least one first service provision device 3. The operating plan is optionally determined by way of robust optimization.

In a sixth step S6, service provision network 1 is operated according to the operating plan.

In an optional seventh step S7, at least one secondary condition is established. In particular, the costs of service provision network 1 are optimized as at least one secondary condition.

FIG. 3 shows a flow chart of a design example of the method for determining a confidence interval from historical values.

In a first determination step BS1, the historical values of the load or the performance are provided. In particular, the historical values include a plurality of values 11, wherein each value 11 has in particular a determination time point, an actual value, and a prediction value.

In a second determination step BS2, a deviation from the respective actual value to the predicted value is calculated for a plurality of values 11, in particular for each value 11.

In a third determination step BS3, a plurality of values 11 are selected and summarized in at least one histogram. In particular, the frequencies with which the deviations enter into predetermined deviation intervals are recorded in the at least one histogram.

In a fourth determination step BS4, the predetermined proportion is specified, wherein, depending on the predetermined proportion, a first deviation and a second deviation are determined in such a way that the predetermined proportion of the deviations of the plurality of values 11 is between the first deviation and the second deviation.

In a fifth determination step BS5, the confidence interval is determined from the histogram and the predetermined proportion, in particular from the first deviation and the second deviation.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a service provision network, the method comprising the steps of:
providing that the service provision network includes at least one first service provision device with a predeterminable performance and at least one second service provision device with a non-predeterminable performance;
determining an operating plan for operating the service provision network at least via a prediction horizon, depending on a load prediction of a load demand to the service provision network and a performance prediction for the at least one second service provision device for the prediction horizon, which is a respectively same predetermined prediction horizon;
determining, additionally, the operating plan, depending on a load confidence interval of the load prediction and on a performance confidence interval of the performance prediction, such that, at any point in time within the prediction horizon, a current performance prediction for the service provision network is at least as great as a current upper limit of the load confidence interval; and
operating then the service provision network according to the operating plan.

2. The method according to claim 1, wherein the method includes the step of determining, additionally, the operating plan, depending on the load confidence interval of the load prediction and on the performance confidence interval of the performance prediction, such that, at any point in time within the prediction horizon, the current performance prediction for the service provision network, taking into account the performance confidence interval, is at least as great as the current upper limit of the load confidence interval.

3. The method according to claim 1, wherein the current performance prediction for the service provision network is calculated as a sum of a current lower limit of the performance confidence interval and a current performance of the at least one first service provision device.

4. The method according to claim 1, wherein the operating plan is determined depending upon at least one secondary condition.

5. The method according to claim 4, wherein a plurality of costs of the service provision network are minimized as the at least one secondary condition.

6. The method according to claim 1, wherein the operating plan is determined by way of robust optimization.

7. The method according to claim 1, wherein at least one confidence interval, selected from the load confidence interval and the performance confidence interval, is determined from a plurality of historical values.

8. The method according to claim 7, wherein a plurality of deviations of the plurality of historical values of a plurality of historical value predictions assigned to the plurality of historical values are determined, and wherein a lower limit and an upper limit of the at least one confidence interval are determined based on the plurality of deviations which are determined, such that, for a predetermined proportion of the plurality of deviations, a sum of (a) a respective one of the plurality of deviations and (b) at least one of (i) the load prediction and (ii) the performance prediction is within a respective one of the at least one confidence interval.

9. The method according to claim 8, wherein the predetermined proportion depends on (i) a demand parameter, (ii) a relevance of a facility to be supplied with a service or an application, and (iii) a system relevance value.

10. The method according to claim 8, wherein the predetermined proportion depends on (i) a demand parameter, (ii) a customer request, (iii) a relevance of a facility to be supplied with a service or an application, and (iv) a system relevance value.

11. A control device of a service provision network, the control device comprising:
the control device, which is structured and arranged to perform a method for operating the service provision network, the method including the steps of:
providing that the service provision network includes at least one first service provision device with a predeterminable performance and at least one second service provision device with a non-predeterminable performance;
determining an operating plan for operating the service provision network at least via a prediction horizon, depending on a load prediction of a load demand to the service provision network and a performance prediction for the at least one second service provision device for the prediction horizon, which is a respectively same predetermined prediction horizon;
determining, additionally, the operating plan, depending on a load confidence interval of the load prediction and on a performance confidence interval of the performance prediction, such that, at any point in time within the prediction horizon, a current performance prediction for the service provision network is at least as great as a current upper limit of the load confidence interval; and
operating then the service provision network according to the operating plan.

12. A service provision network, comprising:
a control device;
at least one first service provision device with a predeterminable performance; and
at least one second service provision device with a non-predeterminable performance, the control device being structured and arranged to perform a method for operating the service provision network, the method including the steps of:
determining an operating plan for operating the service provision network at least via a prediction horizon, depending on a load prediction of a load demand to the service provision network and a performance prediction for the at least one second service provision device for the prediction horizon, which is a respectively same predetermined prediction horizon;
determining, additionally, the operating plan, depending on a load confidence interval of the load prediction and on a performance confidence interval of the performance prediction, such that, at any point in time within the prediction horizon, a current performance prediction for the service provision network is at least as great as a current upper limit of the load confidence interval; and
operating then the service provision network according to the operating plan.
